(19) United States
(12) Patent Application Publication
(10) Pub. No.: US 2026/0170687 A1
(43) Pub. Date: Jun. 18, 2026

(54) METHOD AND SYSTEM FOR DETERMINING DIRECTION OF GAZE

(71) Applicant: IMMERSIX LTD, TEL AVIV (IL)

(72) Inventors: ORI WEITZ, TEL-AVIV (IL); HAIM PERSKI, HOD HASHARON (IL)

(21) Appl. No.: 19/534,874

(22) Filed: Feb. 10, 2026

Related U.S. Application Data
(63) Continuation of application No. 18/637,482, filed on Apr. 17, 2024, now abandoned.
Application No. 18/637,482 is a continuation of application No. PCT/IL2023/050779, filed on Jul. 26, 2023.

(30) Foreign Application Priority Data
Jul. 28, 2022 (IL) 295191

(51) Int. Cl. G06T 7/73; G06V 40/18

(52) U.S. Cl. CPC G06T 7/74; G06T 2207/30196; G06V 40/193

(57) ABSTRACT

A method and system for determining a direction of gaze of a person, include using a first modality to calculate a first estimated direction of gaze of the person from data (e.g., images) of an eye of the person and using a second modality to calculate a second estimated direction of gaze of the person from data (e.g., the same and/or other images) of the eye of the person. The first and second estimations of direction of gaze are combinedly used to determine the direction of gaze of the person. In some embodiments, the images used in the second modality include retinal features.

### FIELD

The present invention relates to gaze tracking.

### BACKGROUND

Eye tracking to determine direction of gaze (also referred to as gaze tracking) may be useful in different fields, including human-machine interaction control of devices such as industrial machines, in aviation, and emergency room situations where both hands are needed for tasks other than operation of a computer, in virtual, augmented or extended reality applications, in computer games, in entertainment applications and also in research, to better understand subjects' behavior and visual processes. In fact, gaze tracking methods can be used in all the ways that people use their eyes.

Computer vision-based techniques are frequently used for gaze tracking. Commonly used image or video-based tracking methods use corneal reflections and the center of the pupil as features from which to reconstruct the optical axis of the eye and/or as features to track in order to measure movement of the eye. These methods are limited by image quality and/or variations of pupil size, for example, in response to ambient light. Furthermore, measurements, in these methods, are sensitive to the location of the camera relative to the eye. Therefore, even small movements of the camera (called ‘slippage’) can produce errors in the eye orientation estimation and consequently, large errors in the gaze target estimation. These methods typically require recalibration, i.e., it is necessary to know the true gaze target (ground truth) of a user for at least one recent gaze fixation.

Classically, such systems ask the user to look at and fix the user's gaze at specific targets whose locations are known to the system. This is very inconvenient for the user and prevents the user from using the system immediately upon start up, and after that, prevents the user from using the system without interruptions.

Another method collects ground truth for recalibration, during the user's eye fixations, by inferring the user's gaze target from the user's interaction with the system (such as by asking the user to click a button) and through analyzing the saliency of the displayed image or of the scene image (the image the user sees). Such methods, if at all available, are usually too slow and may be inaccurate.

Other gaze tracking methods are less sensitive to variations of pupil size and changes of the position of the camera relative to the eye and thus provide a more accurate measurement of a person's direction of gaze. These methods use images of features from inside the eye, such as the retinal blood vessels, and follow these features as the eye rotates. However, processing of images of features from inside the eye (e.g., retinal images) is typically computationally heavy, adversely affecting widespread use of retinal-image-based gaze tracking.

### SUMMARY

Embodiments of the invention provide methods and systems for gaze tracking which use at least two modalities to estimate the direction of gaze of a person. The combination of two (or more) modalities improves the overall accuracy of gaze direction estimation. In addition, the success rate of the gaze estimation (rate at which gaze estimation is provided with an error lower than a threshold, for example, an error of 2 degree or less) increases as one modality may fail (e.g., in settings or with specific people) but the other modalities may not. Thus, the use of a plurality of modalities, according to embodiments of the invention, provides robust and accurate gaze estimation methods and systems.

The use of a combination of a plurality of modalities also offers a good balance of trade-offs between accuracy, update rate, energy consumption and ease of use of the system.

In some embodiments, the gaze estimations of one modality may be used as ground truths for the recalibration of the other modality. This recalibration may be used to update external parameters of the other modality. In some embodiments, the gaze estimations of one modality may be used to correct errors, drift and/or bias of the other modality. For example, a system may be set up so that a first modality operates at a high update frequency and a second modality operates at low frequency update. The frequency of the second modality can be set to be low enough so that the energy consumption is below a required amount, and high enough to recalibrate the first modality frequently enough to prevent it from becoming inaccurate. In such a system the gaze estimation of the first modality (recalibrated frequently by the second modality) is accurate, fast, has a high update rate and doesn't burden the user with interactive recalibration of the system. Overall, the system has a lower energy consumption than that of the second modality working at a high frequency rate.

One embodiment of the invention provides a method for determining a direction of gaze of a person, which includes using a first modality to calculate a first estimation of the direction of gaze of the person from images of an eye of the person and using a second modality to calculate a second estimation of the direction of gaze of the person from images of the eye of the person. The first estimation and second estimation may be combined to improve the overall estimation of the person's direction of gaze. Thus, the first and second estimations of direction of gaze are used together to determine the direction of gaze of the person.

The first modality typically uses easily detectable or visible features of the eye, such as, corners of the eye, corneal reflections (CR) and the pupil. The features used in the second modality may be less easily detectable features, such as retinal features, e.g., patterns of blood vessels that supply the retina. Thus, the second modality may use retinal images, namely, images in which features of the retina are visible or detectable.

### BRIEF DESCRIPTION OF THE DRAWINGS

The invention will now be described in relation to certain examples and embodiments with reference to the following illustrative drawing figures so that it may be more fully understood. In the drawings:

FIGS. 1A and 1B schematically illustrate, correspondingly, a method and system for gaze tracking, according to embodiments of the invention;

FIG. 2 schematically illustrates a method for controlling a device based on gaze tracking, according to embodiments of the invention;

FIG. 3 schematically illustrates a method for combining modalities to determine direction of gaze, according to embodiments of the invention;

FIG. 4 schematically illustrates a method for combining modalities, according to additional embodiments of the invention; and

FIG. 5 schematically illustrates a method for using different modalities to enhance accuracy of gaze tracking, according to embodiments of the invention.

### DETAILED DESCRIPTION

One embodiment of the invention provides a method for determining a direction of gaze of a person, which includes using a first modality to calculate a first estimation of the direction of gaze of the person from images of an eye of the person, and using a second modality to calculate a second estimation of the direction of gaze of the person from images of the eye of the person. The first estimation and second estimation may be combined to improve the overall estimation of the person's direction of gaze.

For example, a first modality may be very fast to compute, may have a high update frequency, may have low latency, may consume little overall energy, may be accurate for short time spans, may typically exhibit drift and/or bias after longer time spans, and may rely on external parameters that change over time and therefore may require frequent recalibration to remain accurate. A second modality may be very accurate, may remain accurate for long time spans, may not require frequent recalibration or may require no recalibration at all, may consume more energy, may be slower to compute and may have a low update frequency and high latency. Combining two such modalities provides methods and systems having overall low energy consumption and accurate gaze tracking with no inconvenience for the user.

Although the examples described herein refer to two modalities, it should be appreciated that more than two modalities may be combined to provide gaze tracking according to embodiments of the invention.

Additionally, although the examples described herein refer to the use of cameras, it should be appreciated that other sensors may be used and embodiments of the invention may include camera-free methods. For example, a MEMS (micro electronic mechanical system) laser scanner or IR LEDS (infrared light emitting diodes) may be used with photodetectors, or an IMU (inertial measurement unit) on the eye, may be used. Typically, camera-free methods are extremely high frequency methods but are prone to drift or bias. These methods typically have great precision and good relative accuracy but their absolute accuracy is not as good. Thus, camera-free methods may be used as a first modality together with a second modality, e.g., as described above.

Embodiments of the invention use one or more sensors and, possibly, one or more light sources to determine a direction of gaze of a person. In some embodiments, at least one of the sensors is a camera and the direction of gaze is determined based on images of the person's eye(s) obtained by the camera.

A ray of sight corresponding to a person's gaze (also termed “ray of gaze” or “gaze ray”) includes the origin of the ray and its direction. The origin of the ray can be assumed to be at the optical center of the person's eye lens (hereinafter ‘lens center’) whereas the direction of the ray is determined by the line connecting the origin of the ray and the gaze target. Each of a person's two eyes has its own ray of gaze and under normal conditions the two meet at the same gaze target.

The gaze ray is a straight line defined by two points in the three-dimensional (3D) space. For example, by using, as the two points, the 3D center of the eyeball and the center of the pupil, the ray of sight can be estimated without depending on positions of the camera and the light source with respect to the person.

The direction of the ray of gaze may be derived from the orientation of the eye.

Systems and methods for determining gaze direction of a person, according to embodiments of the invention, are exemplified below.

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “analyzing”, “processing”, “computing”, “calculating”, “estimating”, “determining”, “detecting”, “identifying”, “creating”, “producing”, “predicting”, “finding”, “trying”, “choosing”, “using”, or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices. Unless otherwise stated, these terms refer to automatic action of a processor, independent of and without any actions of a human operator.

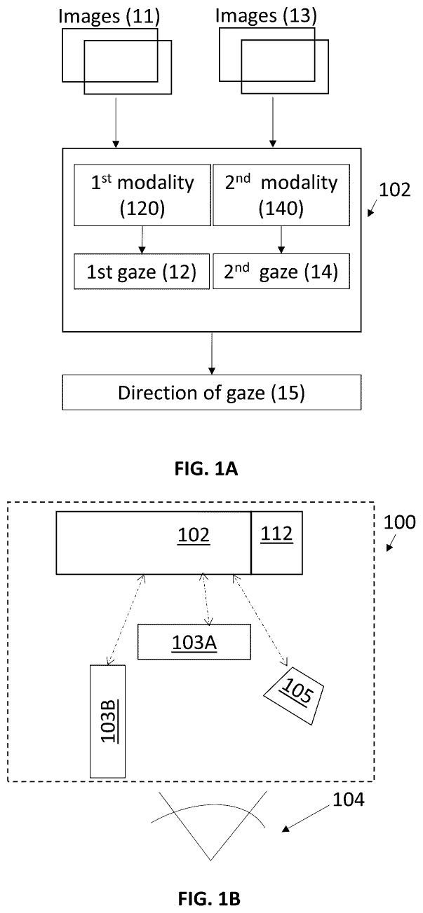

In one embodiment, which is schematically illustrated in FIG. 1A, a method for determining a direction of gaze of a person includes using, e.g., in a processor (such as processor 102 in FIG. 1B), a first modality (120) to calculate a first estimation of direction of gaze (12) of the person, from images (11) of an eye of the person. A second modality (140) is used to calculate a second estimation of direction of gaze (14) of the person, from images (13) of the eye of the person. In one embodiment, images (13) that are used in the second modality (140) include features of the person's retina. The first and second estimations of direction of gaze (12) and (14) are used to calculate the overall estimation of direction of gaze (15), thereby determining the direction of gaze of the person.

The images (11) used in the first modality (120) may include elements of the eye used to calculate an estimation of gaze direction in the first modality (such as the pupil and/or corneal reflections), as well as the retina. At least some of the images (11) may be used to determine gaze direction in the first modality and also in the second modality. Thus, the images (13) used in the second modality (140) may include at least some of the images (11) used in the first modality (120).

The first and second modalities (120) and (140) typically include different methods by which to calculate estimations of directions of gaze. For example, the first modality may include using camera-less methods, e.g., as listed above, whereas the second modality may include using image-based methods. In another example, the first modality may include tracking features which are easily visible or detectable from an image of a person's eye, and/or determining and tracking relations of these features to one another (e.g., a distance between features, an angle between features, etc.), whereas the second modality may include tracking features visible from images of a retina of the person's eye.

Features that can be tracked from images of an eye, in the first modality, may include, for example, the pupil, corners of the eye, corneal reflections from the front and back of the cornea and reflections from the front and back of the eye lens. Thus, the first modality may include detecting the pupil (e.g., by using bright pupil techniques) in images of the person's eye and calculating a first estimation of direction of gaze based on the pupil. Methods used in the first modality may also be referred to herein as pupil-based or P-CR (pupil-corneal reflection) methods.

In one exemplary method, a P-CR method uses a source of near-infrared or infrared light to illuminate the pupil and which generates a reflection on the cornea. It is assumed that the eye is a sphere that only rotates around its center, and that the camera and light source are fixed. The position of the CR does not move with the eye rotation, and therefore can be used as a reference point, whereas the pupil moves with rotation of the eye. The distance between the pupil (or center of the pupil) and the CR defines a vector in the image, which can be mapped to known coordinates during a calibration procedure. This vector can be used to track rotations of the eye and thus changes in direction of gaze.

The second modality may include a method for more precisely determining rotations of the eye, for example by using less visible or detectable features of the eye, e.g., retinal features (such as, patterns of blood vessels that supply the retina). Although rotations of the eye around the gaze direction (torsional movements) do not change the gaze direction, a more accurate measurement can be performed if the rotation is not constrained to having no torsional component. Therefore, for a more accurate method of gaze tracking, torsional movements are taken into account and images of retinal features of the eye are aligned by mapping one to the other through a 3D spherical rotation (which is equivalent to a 3D rotation matrix).

Thus, for example, the second modality may include detecting, in retinal images of the person's eye, retinal features and using the retinal features to determine a direction of gaze of the person, e.g., by detecting a spatial transformation mapping retinal features in a reference image captured at a known direction of gaze of a person to the same retinal features in an input image captured at an unknown direction of gaze of the person. In some embodiments, the detected transformation is converted to a corresponding spherical rotation and the direction of gaze associated with the input image is determined by using the spherical rotation to rotate the known direction of gaze associated with the reference image. In some embodiments, planar camera images are projected to a sphere and instead of (or in addition to) comparing the planar translation and rotation of two retinal images, they are compared through a rotation of a sphere. Rotation of a sphere can be around any axis and is not limited just to ‘roll’. A spherical rotation has three degrees of freedom that are analogous to the two degrees of freedom of planar translation plus the one degree of freedom of planar rotation. Thus, the second estimation of direction of gaze, according to embodiments of the invention, can be calculated based on spatial transformation of retinal images, including spherical rotations.

The first modality (120) and the second modality (140) may be used in parallel, concurrently or simultaneously, where the first estimation of direction of gaze (12) is calculated at the same time or substantially at the same time as the calculation of the second estimation of direction of gaze (14). In other embodiments the first and second modalities are not used concurrently but rather each of the modalities is initiated at a different time and/or depending on different conditions.

In some embodiments the two modalities have different latencies, namely, the computation time or time of obtaining an estimation from each modality may be different. In some embodiments, the first modality has a lower latency than the latency of the second modality. For example, using images obtained at the same time, a first estimation of direction of gaze may be provided quicker than a second estimation of direction of gaze. Significantly more computation may be required to obtain an estimated direction of gaze using the second modality. In some embodiments, the two modalities achieve the same latency by dedicating many more compute resources to the second modality. In other embodiments, the second modality may have a much higher latency than the first modality due to fewer compute resources dedicated to it. Limited compute resources allow for a smaller dedicated chip and in turn, reduced power leakage.

The overall estimation of direction of gaze of the person (15) is determined based on both the first estimation of direction of gaze (12) and on the second estimation of direction of gaze (14). In one embodiment, a statistic of the first estimation of direction of gaze and the second estimation of direction of gaze is calculated (for example, an average of the two estimations) and the overall estimation of direction of gaze of the person (15) is determined based on the statistical calculation of both estimations of direction of gaze (12) and (14). In some embodiments, a weight may be assigned to each of the first and second estimations of directions of gaze, for example, based on a confidence level of the first and second modality, correspondingly. The overall estimation of direction of gaze of the person (15) can then be determined based on the weighted estimations of direction of gaze (and/or on statistical calculations of the first and second estimations of direction of gaze).

FIG. 1B schematically illustrates a system 100, operable according to some embodiments of the invention. The system 100 includes one or more camera(s) 103A and 103B configured to obtain images of at least a portion of one or both of a person's eye(s) 104. At least one camera 103A or 103B is a retinal camera, which obtains an image of a portion of the person's retina (where retinal features are more easily detectable), possibly via the pupil of the eye, with minimal interference or limitation of the person's field of view. For example, a camera may be located at the periphery of a person's eye (e.g., below, above or at one side of the eye) a couple of centimeters from the eye. In one embodiment, the camera is located less than 10 centimeters from the eye. For example, the camera may be located 2 or 3 centimeters from the eye. In other embodiments the camera is located more than 10 cm from the eye, e.g., a few tens of centimeters or even several meters from the eye.

Camera 103A and/or 103B may include a CCD or CMOS or other appropriate image sensor and an optical system which may include, for example, a lens (e.g., lens with wide depth of field, lens having adjustable focus, multi-element lens, etc.), mirrors, filters, beam splitters and polarizers. In other embodiments, camera 103A and/or 103B may include a standard camera provided, for example, with mobile devices such as smartphones or tablets.

System 100 may include one or more light source(s) 105 configured to illuminate the person's eye 104. Light source 105 may include one or multiple illumination sources and may be arranged, for example, as a circular array of LEDs surrounding the camera and/or its lens. Light source 105 may illuminate at a wavelength which is undetected by a human eye (and therefore unobtrusive), for example, light source 105 may include an IR LED or other appropriate IR illumination source. The wavelength of the light source (e.g., the wavelength of each individual LED in the light source), may be chosen, for example, to maximize the contrast of features in the retina and to obtain an image rich with detail.

In some embodiments, light source 105 may include a miniature light source positioned in close proximity to the camera lens, e.g., in front of the lens, on the camera sensor (behind the lens) or inside the lens.

In one embodiment, light source 105 includes a filter or an optical component to produce light in a certain polarization for illuminating a person's eye 104, or is a naturally polarized source, such as a laser.

In an alternative embodiment, camera 103A and/or 103B includes a photosensor and light source 105 includes a laser scanner (e.g., MEMS laser scanner) or IR LEDs.

A processor 102 is in communication with camera(s) 103A and 103B to receive image data from the camera(s) and to calculate two (or more) estimations of directions of gaze of a person, based on the received image data, using two (or more) different modalities, and combining the plurality of estimations of direction of gaze to calculate an overall estimation of direction of gaze of the person.

A method that combines two (or more) modalities for calculating estimations of direction of gaze, is more accurate than a method using only a first of these modalities, and typically requires less energy than each of the modalities used separately.

In some embodiments, the system includes two (or more) sensors, such as cameras 103A and 103B, and data used in the first modality is captured by a first sensor whereas data used in the second modality is captured by the second sensor. E.g., images used in a first modality are captured by a first camera whereas the images used in the second modality are captured by a second, different, camera. In other embodiments, data used in each of the different modalities is provided by the same sensor, e.g., the same camera.

Processor 102 may be in communication with the light source 105 to control the light source 105. For example, light source(s) 105 may be differentially controlled in the first and second modalities. Different light sources 105 and/or different illumination patterns (e.g., illumination in different wavelengths and/or from different angles) and/or different illumination schedules may be used. In some embodiments, the system includes two (or more) light sources where different light sources are used in the first modality and in the second modality. In other embodiments, the same light source is used in each of the different modalities.

In some embodiments, processor 102 may be in communication with a user interface device including a display, such as a monitor or screen, for displaying images, instructions and/or notifications to a person (e.g., via text or other content displayed on the monitor). In other examples, processor 102 may be in communication with a storage device such as a server, including for example, volatile and/or non-volatile storage media, such as a hard disk drive (HDD) or solid-state drive (SSD). The storage device, which may be connected locally or remotely, e.g., in the cloud, may store and allow processor 102 access to databases of reference images, maps linking reference images to known directions of gaze, etc.

Processor 102 may also be in communication with a device, to control the device in accordance with a calculated direction of gaze, e.g., as further described herein.

Processor 102 may be in communication with one or more components such as a user interface device, a storage device and a device to control.

Components of system 100 may be in wired or wireless communication and may include suitable ports and/or network hubs.

Processor 102, which may be locally embedded or remote, may include, for example, one or more processing units including a central processing unit (CPU), a graphics processing unit (GPU), a digital signal processor (DSP), a field-programmable gate array (FPGA), a microprocessor, a controller, a chip, a microchip, an integrated circuit (IC), or any other suitable multi-purpose or specific processing or controlling unit.

Processor 102 is typically in communication with a memory unit 112, which may store at least part of the data received from sensors, such as, camera(s) 103A and/or 103B. Memory unit 112 may be locally embedded or remote. Memory unit 112 may include, for example, a random access memory (RAM), a dynamic RAM (DRAM), a flash memory, a volatile memory, a non-volatile memory, a cache memory, a buffer, a short-term memory unit, a long-term memory unit, or other suitable memory units or storage units.

In some embodiments, the memory unit 112 stores executable instructions that, when executed by processor 102, facilitate performance of operations of processor 102, as described herein.

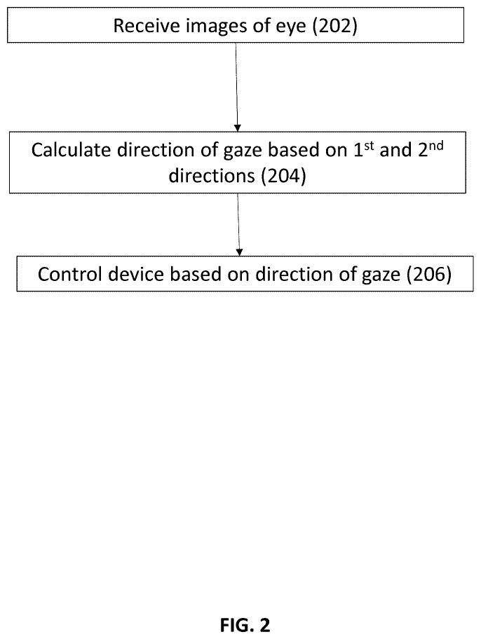

As schematically illustrated in FIG. 2, processor 102 receives data, e.g., images, of one (or both) of a person's eye (step 202) and calculates an overall estimation of direction of gaze of the person (step 204) by using a first modality to calculate a first estimation of direction of gaze of the person from at least some of the data (e.g., images) and a second modality to calculate a second estimation of direction of gaze of the person from at least some of the data (e.g., images, which may be at least some of the same images used in the first modality) and combining the first estimation of direction of gaze and second estimation of direction of gaze.

Once the overall estimation of direction of gaze of the person is determined, processor 102 may use the direction of gaze to control a device (step 206). For example, devices controlled based on a person's direction of gaze may include industrial machines, devices used in sailing, aviation or driving, devices used in medical procedures, devices used in advertising, devices using virtual or augmented or mixed reality, computer games, devices used in entertainment, etc. Alternatively or in addition, a device for biometric person identification may be controlled based on the person's direction of gaze, according to embodiments of the invention.

Processor 102 may use the first modality and the second modality concurrently or at different times. In one embodiment, the first modality is used or operates at a different frequency than the second modality. For example, the first modality may be used more frequently than the second modality or the first modality may operate at a higher frequency than the second modality.

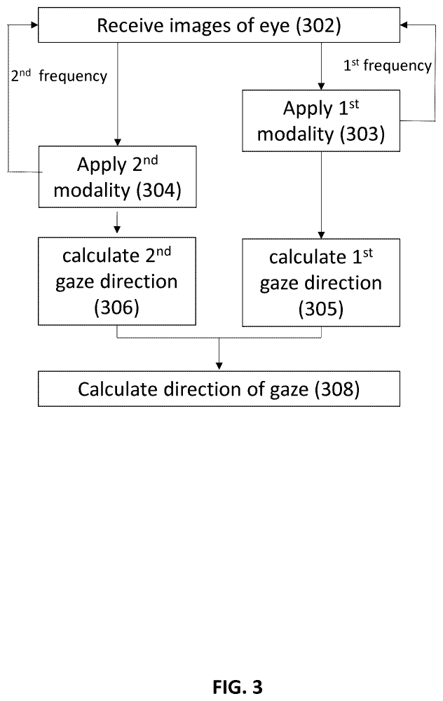

In the example schematically illustrated in FIG. 3, processor 102 receives images of one (or both) of a person's eye (step 302) and uses some or all of the images in a first modality (step 303) to obtain a first estimation of direction of gaze (step 305). In parallel, but typically not at the same frequency, processor 102 uses some or all of the images in a second modality (step 304) to obtain a second estimation of direction of gaze (step 306).

The data (e.g., images) used in the first modality may be different than the data (e.g., images used in the second modality. For example, images used in the first modality may be captured by a different camera than images used in the second modality. Additionally or alternatively, images used in the first modality may be obtained by using a different illumination source or different illumination pattern or schedule than the illumination source, pattern or schedule used in the second modality.

The first estimation of direction of gaze and second estimation of direction of gaze are then used (e.g., calculated) to produce the person's overall estimation of direction of gaze (step 308).

The first estimation of direction of gaze may be obtained at a first frequency or rate. For example, 60 images per second are processed in a first modality, to obtain 60 estimations of direction of gaze every second, whereas the second direction of gaze may be obtained at a second, different, frequency or rate, e.g., only 2 images are processed per second in a second modality, to obtain 2 estimations of direction of gaze every second. An overall estimation of direction of gaze based on both first and second estimations, may be calculated at predetermined time points (or after a predetermined number of images or frames have been captured or processed) and/or based on other conditions or triggers, as further exemplified herein.

The first modality may have a lower latency than the latency of the second modality. In this case, the first estimation of direction of gaze may be obtained before the second estimation of direction of gaze. The first and second estimations of direction of gaze may be obtained at different rates or frequencies or at the same rates or frequencies.

In one embodiment, the first modality typically includes a low computational cost method, such as a P-CR or pupil-based methods, whereas the second modality includes a more computationally heavy method, such as using retinal images, e.g., as described herein. By using the second modality at a lower frequency than the first modality, direction of gaze can be determined with a reduced computational burden. Thus, using a combination of different modalities at different frequencies, e.g., as described above, may require less energy than using a single modality (e.g., only the second modality) to calculate an accurate direction of gaze. Moreover, by limiting the compute resources dedicated to, for example, the second modality and paying for it with a higher latency for the second modality, a smaller IC (integrated circuit) may be used. Smaller IC typically have less power leakage.

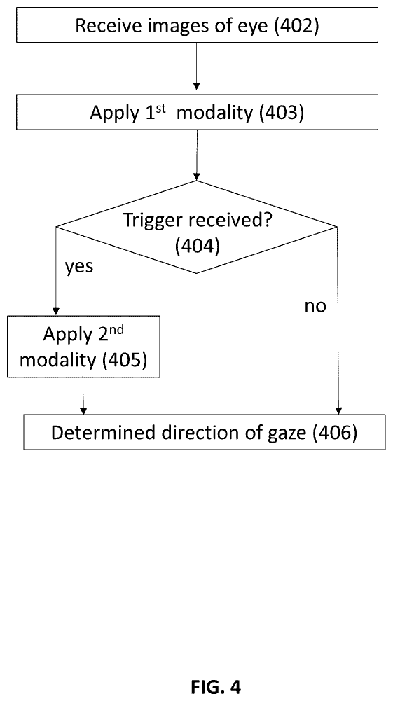

In one embodiment, which is schematically illustrated in FIG. 4, the first modality is typically used continually, whereas the second modality may be used only upon receiving a trigger signal. In this example, processor 102 receives images of one (or both) of a person's eye (step 402) and uses some or all of the images to obtain a first estimation of direction of gaze in a first modality (step 403). If a trigger signal is received (step 404) then processor 102 uses some or all of the images to obtain a second estimation of direction of gaze in a second modality (step 405). If no trigger signal is received (step 404) then the images are continued to be processed in the first modality. The overall estimation of direction of gaze of the person is determined (in step 406) based on the first estimation of direction of gaze determined using the first modality and on the second estimation of direction of gaze using the second modality.

As described above, the trigger signal may be time based. Thus, the second modality may be applied periodically, e.g., at a predetermined frequency and/or based on a number of frames captured or processed.

In some embodiments, the trigger signal may be generated responsive to a change detected in the first direction of gaze. Thus, data obtained in a first modality may be used to determine changes in direction of gaze of the person, which can be a trigger for using the second modality. For example, images of a person's eye (one or both eyes) may be processed using a first modality (e.g., based on measurements of the pupil) to determine a direction of gaze of the person. If a change (e.g., above a predetermined threshold) in the direction of gaze of the person is detected, then the images (possibly the same images or different images, e.g., images obtained by the same or different camera) are processed using a second modality (e.g., based on images of retinal features) to determine the direction of gaze of the person. The direction of gaze of the person may be a combination or calculation of both directions estimated using the first modality and second modality.

A change in a person's direction of gaze may indicate, for example, a new fixation point of the eye of the person. Processor 102 may compare directions of gaze obtained using the first modality, and when a direction of gaze is determined to have changed and the change is stable (e.g., over time), then it is determined that the person's eye is at a new fixation point and this can trigger the use of the second modality. A change may be detected when a direction of gaze is determined to be e.g., at a different angle than the immediately preceding directions or directed to a different target than the immediately preceding target. Typically, a direction of gaze is determined to be at a different angle or directed to a different target when the differences between the angles or targets are above a predetermined or dynamically determined threshold.

In some embodiments several triggers may be used in order to decide to switch from using the first modality to using the second modality. For example, processor 102 may switch to using the second modality if, in step 404, either a first trigger signal is received or a second trigger signal is received, whichever comes first. Thus, for example, images may be processed in a first modality until a change in the eye's fixation point is detected or until a predetermined time has passed, whichever happens first, after which, the images are processed in a second modality.

In some embodiments, one modality or a direction of gaze determined by using the one modality, can be used to confirm or re-calibrate or correct errors and/or bias and/or drift in the other modality, to improve accuracy of the direction of gaze determined by the other modality. For example, if images obtained by the second modality (e.g., using retinal images) are difficult to correctly analyze (e.g., as described below), measurements provided by the first modality may be used to assist in analyzing and may be used to confirm images obtained in the second modality or to correct possible errors in calculations performed in the second modality. In another example, parameters of the first modality may be updated (e.g., to re-calibrated the first modality and/or to correct bias or drift) based on measurements provided by the second modality.

Thus, both first and second modalities can be used in combination to provide an accurate measurement of a person's direction of gaze.

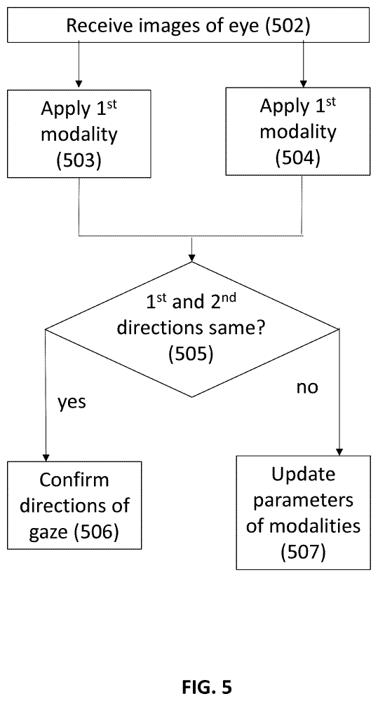

In one embodiment, which is schematically illustrated in FIG. 5, processor 102 receives images of one (or both) of a person's eye (step 502) and uses some or all of the images to obtain a first estimation of direction of gaze in a first modality (step 503). Processor 102 also uses some or all of the images to obtain a second estimation of direction of gaze in a second modality (step 504). The first and second modalities may be run concurrently or at different frequencies and/or having different latencies, as described herein. The first and second estimations of direction of gaze are compared and if there is no difference (e.g., above a threshold) (step 505) then the first estimation of direction of gaze and/or the second estimation of direction of gaze can be confirmed (step 506). If there is a difference (e.g., above a threshold) then parameters of the first modality may be updated according to the second estimation or vice versa (step 507). Thus, parameters of a less accurate modality (e.g., pupil-based or P-CR) may be updated based on measurements provided by a more accurate modality (e.g., retina-based).

In another embodiment, the first and second estimations of direction of gaze are compared and if there is a difference (e.g., above a threshold) (step 505) then the estimation of gaze calculated by one modality can be used to correct drift and/or bias of another modality. For example, drift or bias of the first modality can be corrected based on the second estimation of direction of gaze.

Also, a more accurate but heavy processing modality may be confirmed or corrected by a less accurate but computationally lighter processing modality.

For example, a parameter of the first modality that can be updated based on measurements of the second modality includes a measurement of the center of the eyeball. In one example, the 3D center of the eyeball may be calculated using the second modality (e.g., using retinal features) and the first modality is then used to calculate the first direction of gaze based on the pupil and the calculated 3D center of the eyeball. Calculating the 3D center of the eyeball using retinal features may include, e.g., obtaining first and second (and possibly a third and fourth, etc.) rays of gaze from retinal images of a person's eye (e.g., as described herein), while the person is looking at first and second targets and while the camera is not moving relative to the eye. The intersection point of all of these rays of gaze is the 3D center of the eyeball.

In another example, the second modality includes detecting a spatial transformation mapping retinal features in a reference image captured at a known direction of gaze of the person to same retinal features in an input image captured at an unknown direction of gaze of the person and determining an estimation of direction of gaze based on the spatial transformation. Using the output of calculation of a first modality (e.g., based on a pupil in an image of the eye), false positive matches between the retinal features of the input image and the reference image can be detected and may be ruled out. Thus, the output of the one modality may be used as a helping input (e.g., initial guess) to the other modality, to reduce the computational complexity of the other modality and/or to correct errors in the other modality.

Embodiments of the invention advantageously combine modalities of calculating estimated directions of gaze to obtain accurate overall estimation of a person's direction of gaze while reducing overall computational burden.

What is claimed is:

1. A method for determining a direction of gaze of a person, the method comprising:
using a first method to calculate a first estimated direction of gaze of the person from images of an eye of the person;
using a second method to calculate a second estimated direction of gaze of the person from images of the eye of the person, the images used in the second method comprising retinal features;
using measurements of the first method, which are used to determine the first estimated direction of gaze, to correct calculations performed in the second method, thereby obtaining a corrected second method and using the second estimated direction of gaze to update parameters of the first method, thereby obtaining a calibrated first method; and
determining the direction of gaze of the person using one or both of the calibrated first method and the corrected second method.

2. The method of claim 1 wherein the second method comprises matching retinal features in an input image, captured at an unknown direction of gaze of the person, and retinal features in a reference image, captured at a known direction of gaze of the person.

3. The method of claim 2 wherein using measurements of the first method to correct calculations performed in the second method, comprises detecting and ruling out false positive matches between the images used in the second method.

4. The method of claim 1 wherein the first method operates at a higher update frequency than the second method.

5. The method of claim 1 wherein the first method has a lower latency than a latency of the second method.

6. The method of claim 1 wherein the images used in the second method comprise at least some of the images used in the first method.

7. The method of claim 1 wherein the images used in the first method are captured by a same camera as the images used in the second method.

8. The method of claim 1 comprising:
receiving a trigger signal; and
using the second method upon receiving the trigger signal.

9. The method of claim 8 wherein the trigger signal is one or both of: a time-based signal and a signal generated responsive to a change detected in the first estimated direction of gaze.

10. The method of claim 9 wherein the change indicates a new fixation point of the eye of the person.

11. The method of claim 1 comprising
assigning a weight to each of the first and second estimated directions of gaze based on a confidence level of the first and second method, correspondingly, to obtain weighted measurements; and
determining the direction of gaze of the person based on the weighted measurements.

12. The method of claim 1 wherein at least some of the images of the eye of the person, comprise a pupil.

13. The method of claim 12 wherein the first method comprises detecting the pupil in the images and calculating the first estimated direction of gaze based on the pupil.

14. The method of claim 12 comprising:
using the measurements of the first method and the second estimated direction of gaze to determine a 3D center of an eyeball of the person; and
using the 3D center of the eyeball to determine the direction of gaze of the person.

15. The method of claim 12 wherein the first method comprises a P-CR (pupil-corneal reflection) method.
